(19) United States
(12) Patent Application Publication
(10) Pub. No.: US 2009/0237038 A1
(43) Pub. Date: Sep. 24, 2009

(54) DOUBLE ALTERNATOR AND ELECTRICAL SYSTEM

(76) Inventor: Ron Heidebrink, Longs, SC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/475,703

(22) Filed: Jun. 1, 2009

Related U.S. Application Data
(63) Continuation-in-part of application No. 11/935,452, filed on Nov. 6, 2007.
Application No. 11/935,452 is a continuation of application No. 11/734,003, filed on Apr. 11, 2007, now Pat. No. 7,291,933.

(51) Int. Cl. H02P 9/48; H02K 7/20; H02K 11/04; H02K 7/10

(52) U.S. Cl. 322/28; 310/112; 310/68 D; 310/75 R

(57) ABSTRACT

A double alternator system includes a first brushless winding assembly to generate a first electrical voltage, a second winding assembly to generate a second electrical voltage, a rotatable shaft common to the first brushless winding assembly and second winding assembly to cause generation of a first electrical voltage and second electrical voltage upon rotation of the shaft, and a housing in which the winding assemblies are disposed and through which the first and second electrical voltages are carried to respective first and second electrical output contacts.

### CROSS-REFERENCE TO RELATED APPLICATIONS

This application is a Continuation-in-Part (CIP) of patent application Ser. No. 11/935,452, filed on Nov. 6, 2007, which is now pending and entitled “Double Alternator and Electrical System for a Vehicle.” The Ser. No. 11/935,452 application is a continuation application of patent application Ser. No. 11/734,003, filed on Apr. 11, 2007, which has issued as U.S. Pat. No. 7,291,933 entitled “Double Alternator and Electrical System for a Vehicle.” This CIP application claims the benefit of priority of both the Ser. No. 11/935,452 and Ser. No. 11/734,003 applications. The published version of the Ser. No. 11/935,452 application, namely Pub. No. US2008/0252081A1 published on Oct. 16, 2008, and and the U.S. Pat. No. 7,291,933 patent issued on Nov. 6, 2007, are each incorporated herein by this reference.

### BACKGROUND OF THE INVENTION

The invention generally relates to the field of electrical current supply systems and more particularly, a double alternator and associated electrical systems.

Motor vehicles have in the past been provided with auxiliary alternators for providing back up power to a vehicle battery. In many cases, these auxiliary systems have also included an auxiliary battery. Providing a separate alternator and battery, however, adds a significant amount of weight to the vehicle, especially if the vehicle is an aircraft, and increases the cost of the vehicle, owing to the unnecessary duplication of alternator parts and mounting hardware. Many prior art systems also suffer the disadvantage that the current produced by one alternator cannot be cross fed to power a single battery.

Accordingly, there remains a need for a double alternator electrical system that is lightweight, reliable, inexpensive to manufacture, simple and cost effective. Also, there is a need for a double alternator that is capable of being mounted on a motor using existing hardware in the same location as a conventional alternator. There is a need for a double alternator for use with a vehicle, and for non-vehicular use. The double alternator should be versatile inasmuch as it is capable of use in single and dual battery vehicle electrical systems and in systems that provide cross feed capability between dual electrical power circuits. In the dual battery system, the double alternator system should be capable of replacing existing production of motor-charging engines. For example, the double alternator system should be capable of replacing a 90 amp alternator and 500 amp single battery system to provide two 250 amp batteries and, in effect, two 45 amp alternators using the same space required by the existing system, and capable of control via voltage regulators, whether internal, external, or one of each. Finally, the double alternator should improve safety and minimize maintenance of the vehicle charging electrical system.

### BRIEF SUMMARY OF THE INVENTION

Therefore it is an object of the invention to provide a lightweight double alternator for a vehicle.

It is another object of the invention to provide a reliable double alternator electrical system for a vehicle.

It is another object of the invention to provide a double alternator system that is simple, inexpensive to manufacture, and thus cost effective.

It is another object of the invention to provide a double alternator system that is versatile inasmuch as it is capable of use in single and dual battery vehicle electrical systems.

It is another object of the invention to provide cross feed capability between dual electrical power circuits.

These and other objects of the present invention are achieved in the preferred embodiments disclosed below by providing an electrical system for a vehicle having a motor. The system includes a housing including an adapter housing disposed between opposing front and rear housing sections and a drive assembly. The drive assembly includes a shaft journalled in the front and rear housing sections and a pulley fixed radially about the shaft for being driven by the vehicle motor. A pair of stators, each including an output winding, provide a multi-phase AC voltage by virtue of a pair of rotors each fixed radially about the shaft for rotation therewith producing a magnetic field to induce the multi-phase AC voltage across the output windings of the stators. Two sets of slip rings, each encircle the shaft and are electrically connected to one of the windings of one of the pair of rotors and insulated from the other slip rings and the shaft, and a pair of multi-phase full wave rectifiers, each electrically connected to one of the stators, receive the three-phase AC voltage produced across the winding of one of the stators and convert the AC voltage to DC voltage. Each of two sets of brushes are electrically connected to one of the slip rings to receive field current from a voltage regulator, and a pair of voltage regulators for control DC voltage output.

According to another preferred embodiment of the invention the electrical system includes a storage battery comprising a main system terminal and a ground terminal connected to a system ground, the main terminal connected to both the of the rectifiers for receiving the DC voltage and providing electrical power to the vehicle.

According to another preferred embodiment of the invention, the voltage regulators are connected to the field windings and sense an amount of current in the system to control an amount provided to the field windings.

According to another preferred embodiment of the invention, the system includes a pair of single pole switches, each one of the pair for selectively connecting the main terminal to one of the field windings.

According to another preferred embodiment of the invention, the system includes a pair of indicator lamps, each one of the pair connected between one of the pair of single pole switches and one of the field windings to indicate whether the field winding is receiving current from the main terminal.

According to another preferred embodiment of the invention, an electrical system includes a housing including an adapter housing disposed between opposing front and rear housing sections and a drive assembly that includes a shaft journalled in the front and rear housing sections and a pulley fixed radially about the shaft for being driven by the vehicle motor. A pair of rotors each include a field winding and are each fixed radially about the shaft for rotation therewith for providing current to produce a magnetic field to induce three-phase AC voltage, and a stator corresponding to each rotor each includes an output winding fixed around one of the rotors for producing the three-phase AC voltage. A set of brushes corresponds to each rotor and a pair three-phase full wave rectifiers are each electrically connected to one of the output windings for receiving the three-phase AC voltage produced across the windings of one of the stators and converting the AC voltage to DC voltage. A pair of voltage regulators each control DC voltage output from one of the rectifiers, and a first storage battery is connected to a system ground and a first electrical power subsystem to receive DC voltage from one of the pair of three-phase full wave rectifiers. A second storage battery connected to a system ground and a second electrical power subsystem to receive DC voltage from the other of the pair of three-phase full wave rectifiers and a cross feed switch selectively cross feeds DC voltage between the first and second subsystems.

According to another preferred embodiment of the invention, the electrical system includes a front bus bar connected to the first power subsystem.

According to another preferred embodiment of the invention, the electrical system includes a computer, ignition, and radio connected to the front bus bar.

According to another preferred embodiment of the invention, the electrical system includes a rear bus bar connected to the second power subsystem.

According to another preferred embodiment of the invention, the electrical system includes interior lights, headlights, seats and an air conditioner connected to the rear bus bar.

According to another preferred embodiment of the invention, the electrical system includes a cross feed contactor between the electrical power subsystems.

According to another preferred embodiment of the invention, the electrical system includes a double pole starter switch.

According to another preferred embodiment of the invention, the system includes a manual double pole master switch.

According to another preferred embodiment of the invention, both batteries are energized to start the vehicle motor.

According to another preferred embodiment of the invention, the system includes a starter for starting the vehicle motor.

According to another preferred embodiment of the invention, the system includes a housing enclosing a pair of rotor windings fixed to a shaft to rotate to produce magnetic fields inducing AC voltage across a stator winding corresponding to each rotor. A rectifier is electrically connected to a one of the pair of stators to convert AC voltage from the first of the pair to DC voltage for charging a storage battery, a rectifier electrically connected to the other of the pair of stators to convert AC voltage from the other stator winding to DC voltage for charging the storage battery. A controller is connected to both of the rotor windings for controlling an amount of voltage supplied to the rotor windings and hence the voltage supplied by the stators to charge the storage battery, and an electrical circuit supplies power to the vehicle connected to the battery.

According to another preferred embodiment of the invention, the voltage regulators employ shunts for measuring output voltage and or amperage from the rectifiers.

According to another preferred embodiment of the invention, the controller equalizes the field current provided to the rotor windings.

According to another preferred embodiment of the invention, the system includes independent annunciator lamps for indicating alternator operating statuses.

According to yet another embodiment of the invention, a double alternator system includes a housing, a shaft rotatably mounted in the housing, a first brushless winding assembly, and a second winding assembly. The first brushless winding assembly includes a first field winding fixed in the housing, a first output winding fixed in the housing, and a first rotor fixed to the shaft to rotate relative to the first field winding and first output winding to induce a first AC voltage in the first output winding upon an introduction of a first current in the first field winding and rotation of the shaft. A first rectifier within the housing is electrically connected to the first output winding to produce a first DC voltage upon induction of the first AC voltage. A first electrical output contact is electrically isolated from the housing and electrically connected to the first rectifier to convey the first DC voltage through the housing. The second winding assembly is positioned within the housing and about the shaft to induce a second AC voltage upon rotation of the shaft. A second rectifier within the housing is electrically connected to the second winding assembly to produce a second DC voltage upon induction of the second AC voltage. A second electrical output contact is electrically isolated from the housing and electrically connected to the second rectifier to convey the second DC voltage through the housing.

According to another embodiment of the invention, a power generation system includes a housing, a shaft rotatably mounted in the housing, a first brushless winding assembly disposed within the housing and about the shaft to generate a first AC voltage upon rotation of the shaft, a first rectifier electrically connected to the first brushless winding assembly to produce a first DC voltage upon generation of the first AC voltage, a second winding assembly disposed within the housing and about the shaft to generate a second AC voltage upon rotation of the shaft, a second rectifier electrically connected to the second winding assembly to produce a second DC voltage upon generation of the second AC voltage, a first electrical output contact disposed outside the housing and electrically connected to the first rectifier to receive the first DC voltage, and a second electrical output contact disposed outside the housing and electrically connected to the second rectifier to receive the second DC voltage.

According to yet another embodiment of the invention, a double alternator system includes a first brushless winding assembly to generate a first electrical voltage, a second winding assembly to generate a second electrical voltage, a rotatable shaft common to the first brushless winding assembly and second winding assembly to cause generation of the first electrical voltage and second electrical voltage upon rotation of the shaft, and a housing in which said winding assemblies are disposed and through which said first and second electrical voltages are carried to respective first and second electrical output contacts.

### BRIEF DESCRIPTION OF THE DRAWINGS

The subject matter that is regarded as the invention may be best understood by reference to the following description taken in conjunction with the accompanying drawing figures in which:

FIG. 1 is a double alternator according to an embodiment of the invention;

FIG. 2 is a schematic of an electrical system including the double alternator;

FIG. 3 is a schematic showing an alternative embodiment of the electrical system;

FIG. 4 is a circuit diagram of another alternative embodiment of the electrical system;

FIG. 5 is also a circuit diagram of an alternative embodiment of the system;

FIG. 6 is a circuit diagram of yet another alternative embodiment of the electrical system;

FIG. 7 is a schematic diagram of a controller for an electrical system including a double alternator;

FIG. 8 is a partially cross-sectioned view of yet another embodiment of a double alternator; and

FIG. 9 is an exploded perspective view of a output winding, field winding and rotor of the double alternator of FIG. 8.

### DETAILED DESCRIPTION OF THE INVENTION

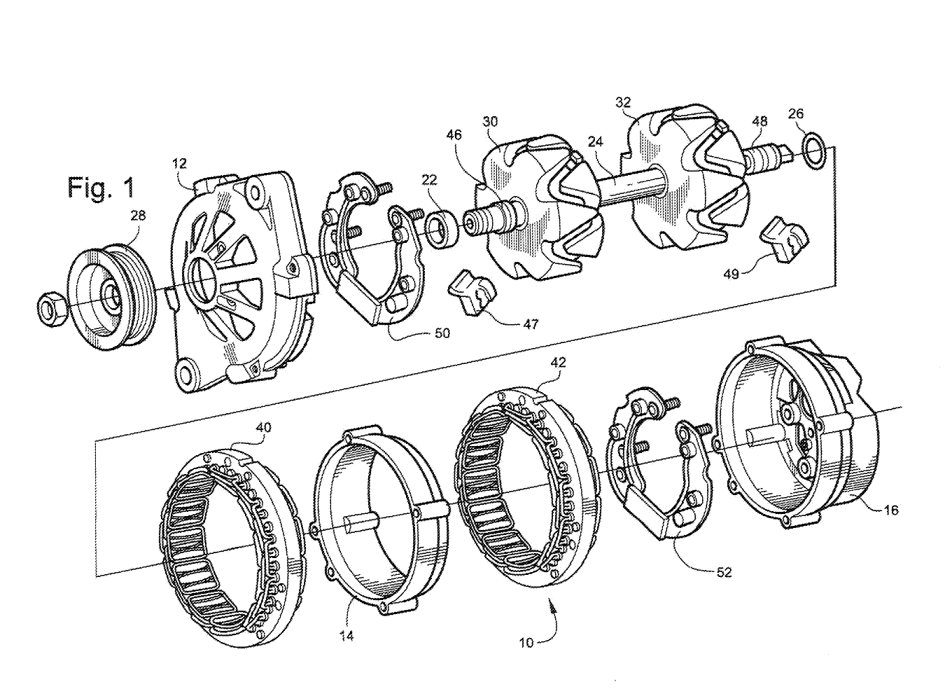

Referring to the drawings wherein identical reference numerals denote the same elements throughout the various views, FIG. 1 is an embodiment of a double alternator 10 for a vehicle having a motor. A housing having an adapter housing 14 is disposed between front 12 and rear 16 housing sections and a drive assembly including a rotatable shaft 24 is journalled in bearings 22 and 26 fitted in the housing. A pulley 28 is fixed radially to the shaft 24 for receiving a belt driven by the vehicle motor (not shown). The double alternator 10 also includes a pair of rotors 30 and 32 each including field windings fixed radially to the shaft 24 for rotation within one of a pair of stators 40 and 42 having windings across which voltage is induced by rotor windings. Two sets of slip rings 46 and 48 encircle the shaft 24 with one of each of the set electrically connected to one of the rotor windings and insulated from the other slip rings and the shaft 24. Each one of a pair of three-phase full wave rectifiers 50 and 52 is connected to one of the stators 40 or 42 and pair of voltage regulators control DC voltage output. One half of the double alternator 10 comprises the rotor 30, stator 40, slip rings 46, brushes 47 and rectifier 50, while the other half comprises the rotor 32, stator 42, slip rings 48, brushes 49 and rectifier 52.

In operation, from an ignition key or switch, voltage is sent to an overvoltage relay, if one is used, to a regulator. The regulator adds positive voltage to a field wire, positive voltage to the brush 49 and the positive slip ring 48 to rotor 32 winding. Voltage flows back out of rotor 32 to a negative slip ring to a negative brush to ground. This circuit field/rotor is turned on and off by the regulator. The regulator is monitoring the output volts. The rotor 32 spinning and with voltage creates a magnetic field. The stator windings 42 are energized by the magnetic fields of the rotor. The stator (normal three phase) produces voltage pulses out to rectifier (diodes). Output of rectifier goes to battery positive lead. Negative diodes are also necessary for DC current, in the invention. This is done by the halves separately and at the same time.

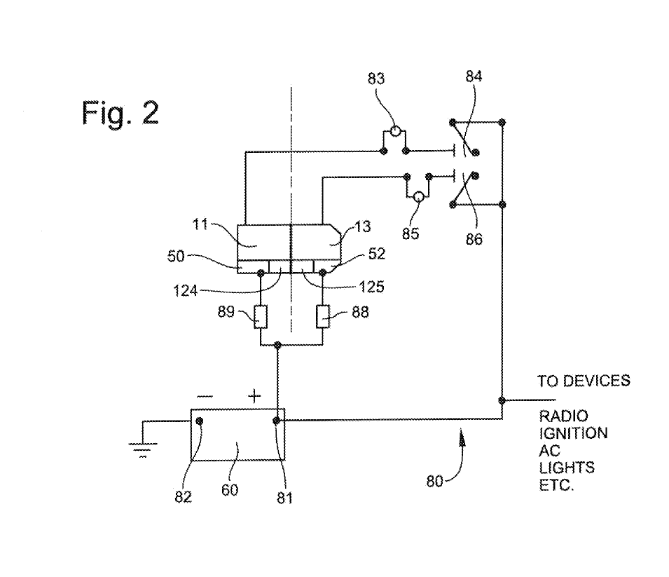

FIG. 2 is a diagram of an embodiment of a basic electrical system 80 for a vehicle including the double alternator 11 and 13. The system 80 includes a storage battery 60 including a main system power terminal 81 and a ground terminal 82 for connection to a system ground. Each rotor is supplied with field current from the battery 60 through one of a pair of single pole switches 84 and 86 and a lamp 83 or 85 is connected between each switch 84 or 86 and the alternator 10 to indicate whether the half of the alternator 11 or 13 to which the lamp 83 or 85 is connected is receiving current. One of a pair of diodes 88 and 89 is connected between each alternator half 11 and 13 and the main power terminal 81 of the battery 60 and the voltage regulators 124 and 125 and rectifiers 50 and 52 are also represented in the figure.

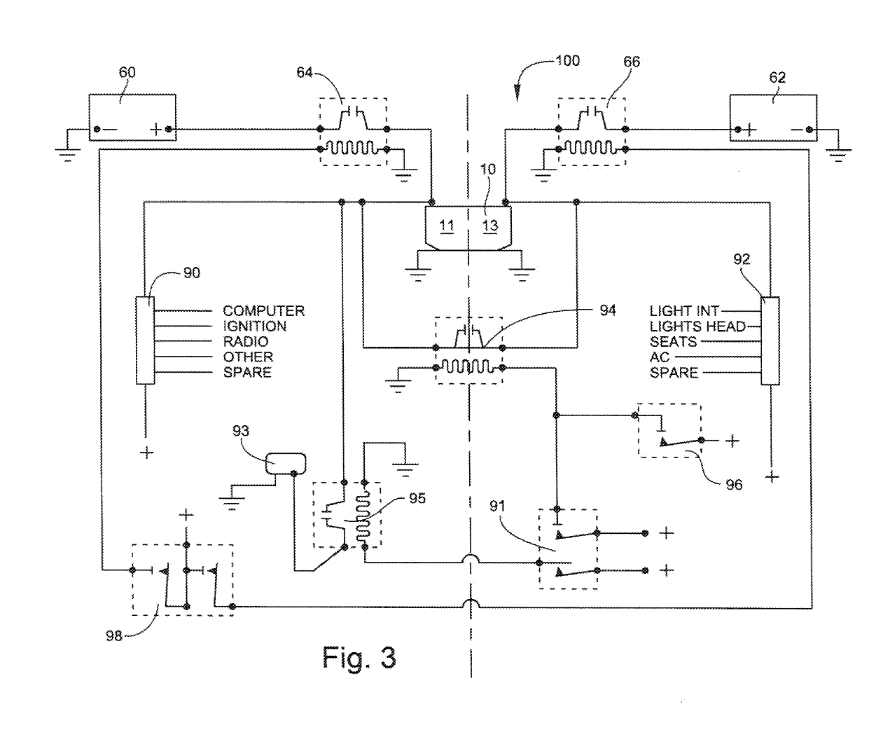

FIG. 3 is another exemplary electrical system 100 for a vehicle including the double alternator having the two halves 11 and 13. In the system represented by FIG. 3, the storage battery 60 is connected to a front busbar 90 where, for example, a vehicle computer, ignition system, and radio can be connected to receive current from the battery 60, and another storage battery 62 is connected to a rear busbar 92 that provides current to interior lights, headlights and air conditioning systems of the vehicle. Output from each of the rectifiers of the double alternator charges one of the storage batteries 60 or 62. In this embodiment of the double alternator electrical system, both batteries 60 and 62 are energized for starting the vehicle via the contactors 64, 66, 94 and 95 and a manual switch 96 is provided to connect a cross feed contactor 94 which cross feeds current between the busbars 90 and 92 so that the vehicle can continue to operate if one half of the double alternator 10 is not charging. The system also includes a starter 93, a manual double pole master switch 98 and a double pole starter switch 91.

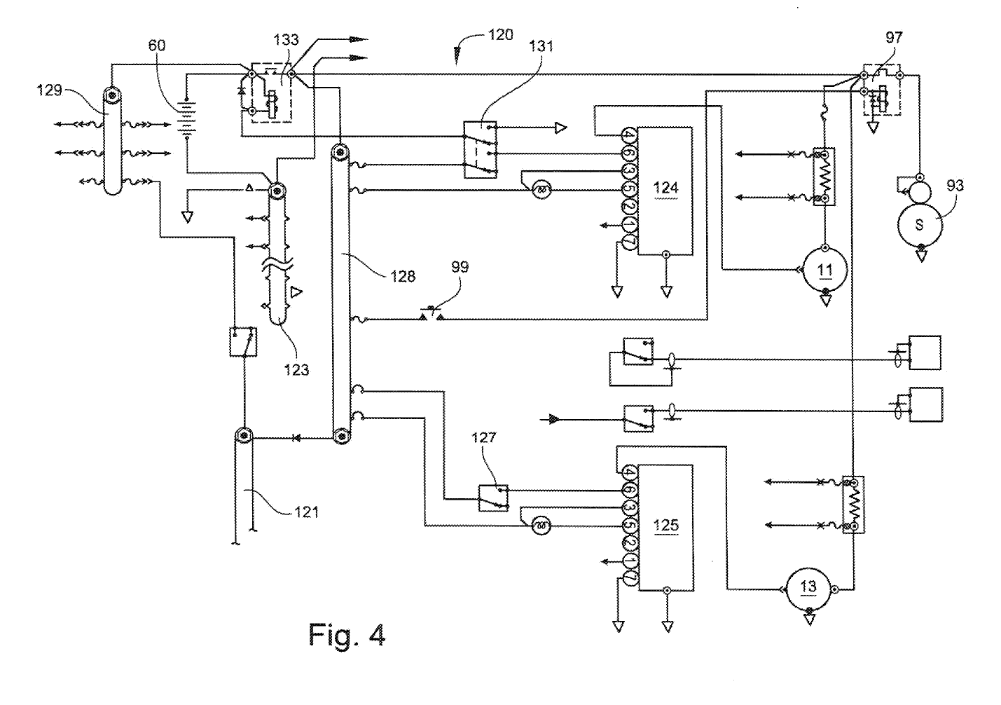

FIG. 4 is a circuit diagram of another exemplary electrical system 120 including the double alternator and a single storage battery 60. The diagram shows a pair of voltage regulators 124 and 125 each connected to control field current supplied to a respective half 11 and 13 of the double alternator from the battery 60. Another switch 127 is provided to selectively bring the half 13 of the alternator 10 online to charge the battery 60 to supply current to a main power bus 128 of the vehicle in the event the half 11 fails to charge. A starter switch 99, contactor 97, and starter 93 are provided for starting the vehicle and an essential busbar 121 is provided for connecting essential operating electronics. The system 120 also includes an instrument panel ground busbar 123 and a battery busbar 129. The battery 60 is connected to the system through a battery master switch 131 and contactor 133.

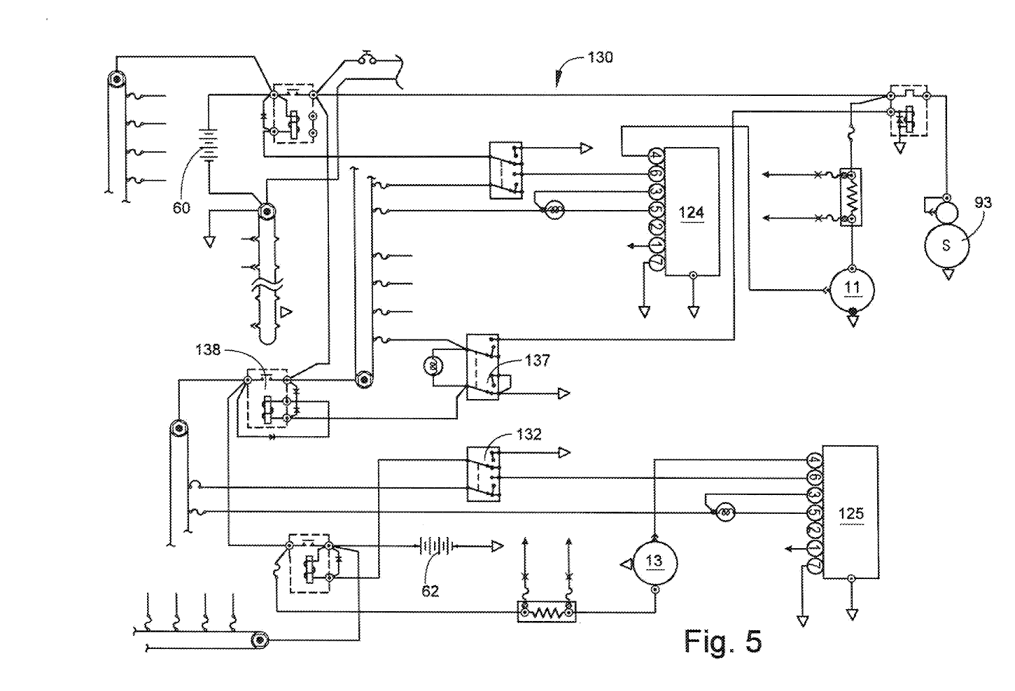

FIG. 5 is a circuit diagram of another alternative embodiment 130 of the electrical system including the double alternator. A primary battery 60 is charged by one half 11 and an auxiliary battery 62 via an auxiliary power switch 132 by the other half 13 of the double alternator. An auxiliary voltage regulator 125 provides a back up system available to power the primary power system via a cross feed switch 137 that closes a cross feed contactor 138.

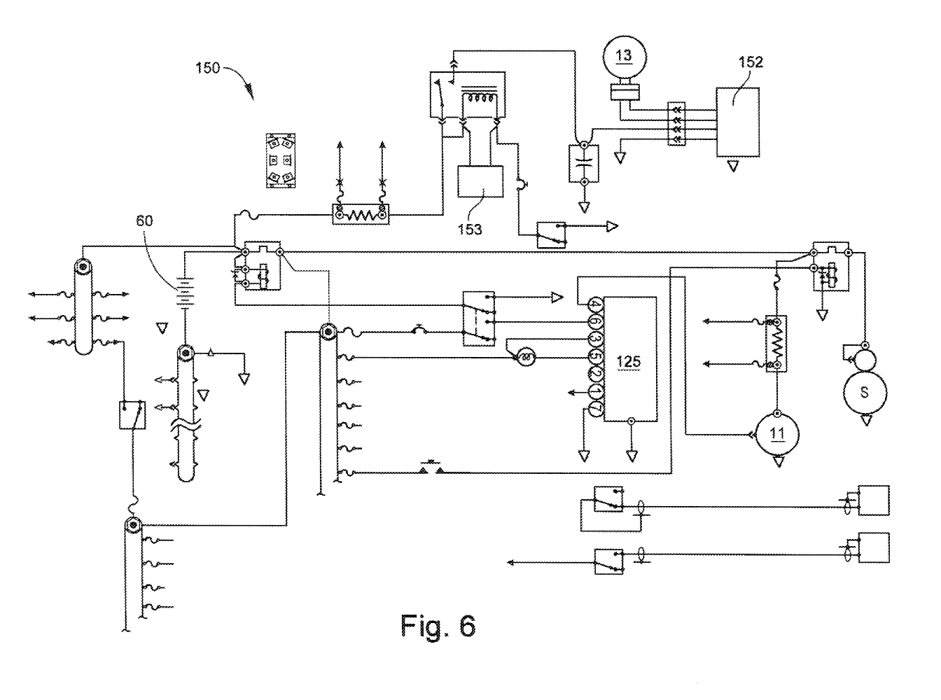

FIG. 6 is a circuit diagram of yet another alternative embodiment 150 of the electrical system including the double alternator and a battery 60. A voltage regulator 152 is provided to control the voltage output of the half 13 of the double alternator serving as an auxiliary alternator and a crow bar circuit 153 is included to prevent overvoltage from damaging the electrical system 150. A voltage regulator 125 is provided for controlling the other half 11 of the alternator.

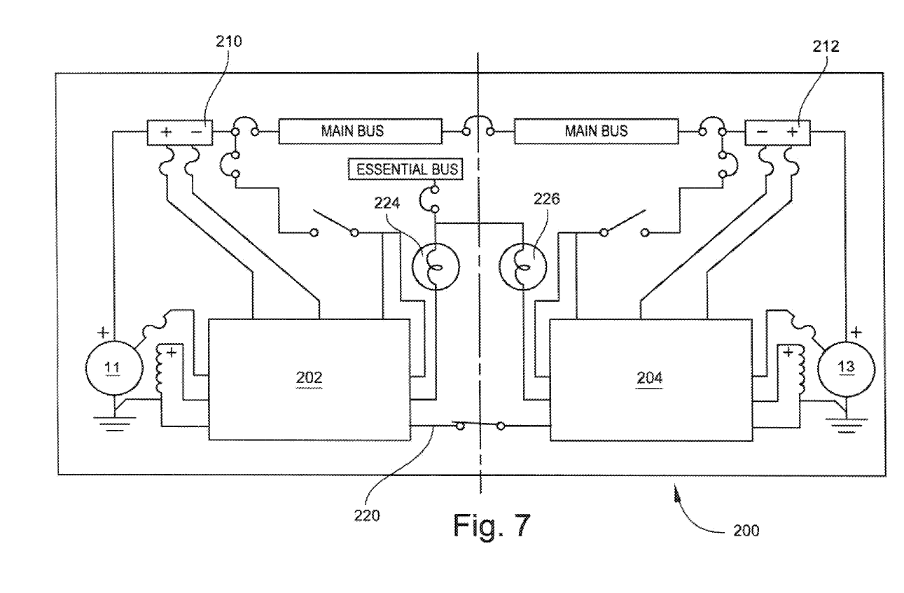

FIG. 7 is a schematic diagram of an embodiment of a controller 200 for the double alternator 10. The controller 200 includes two voltage regulators 202 and 204 that each employ one of a pair of shunts 210 and 212 for measuring the voltage and or amperage output from the halves 11 and 13 of the alternator and adjusting the amount of field current supplied. An equalizer 220 is provided between the two field current outputs and one of a pair of independent annunciators 224 and 226 corresponds to each half 11 and 13 of the double alternator to indicate failures and thus the need to feed voltage from one of the alternator halves 11 or 13 to the other.

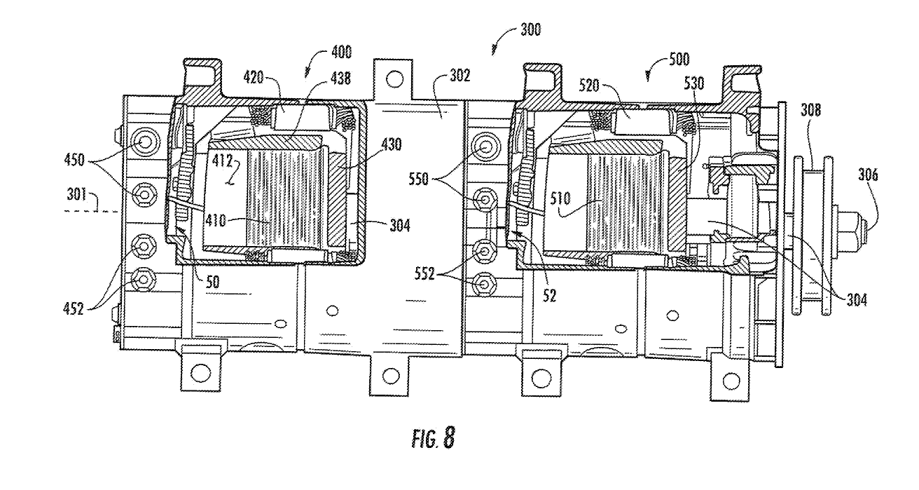

FIG. 8 is a partially cross-sectioned view of yet another embodiment of a double alternator 300 that includes first and second brushless winding assemblies 400 and 500 within a common housing 302. A shaft 304 rotatably mounted in the housing and disposed along a longitudinal axis 301 has a longitudinal end 306 that extends from the housing. A pulley 308 or other mechanical coupling is applied to the longitudinal end of the shaft to rotate the shaft when electrical power is to be produced by the first and second brushless winding assemblies. The double alternator 300 may serve, for example, as the alternator for a fuel combustion engine such as the motor of a motorized vehicle or may be mounted to a stationary support structure for stationary use in an electrical power generation system.

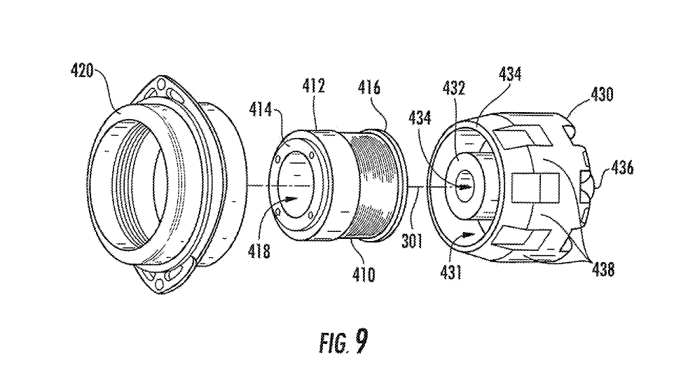

The first brushless winding assembly 400 includes a first field winding 410, a first output winding 420, and a first rotor 430. The first field winding 410 is coiled about a spool 412 having longitudinal ends 414 and 416 and an internal bore 418 (FIG. 9) defined between the ends and around the longitudinal axis 301. The spool 412 is attached to the housing 302 at its longitudinal end 414 and maintains the first field winding 410 in a fixed position relative to the housing as the shaft 304 is rotated

The first rotor 430 has a central core 432 (FIG. 9) having an internal bore 434 that engages the shaft 304 (FIG. 8). The rotor 430 also has an outer body 434 connected to the central core at a first end 436 of the body. The outer body 434 extends around the first field winding 410, which is positioned within an annular volume 431 defined between the central core 432 and the outer body 434. Outer fins 438 extend radially outward from the outer body 434 of the rotor. As the shaft 304 is rotated, all portions of the rotor 430 turn with the shaft while the first field winding 410 remains stationary relative to the housing.

The first output winding 420 is attached to the housing 302 radially outward from the first rotor 430 with respect to the longitudinal axis 301. The first output winding permits rotation of the rotor while remaining stationary relative to the housing. As the first rotor 430 turns with the shaft 304, the outer fins 438 of the rotor pass near to the output winding.

For electrical power production by the first brushless winding assembly, a first current is passed through the first field winding 410, which generates a magnetic field within the internal bore 418 (FIG. 9) of the spool 412. The generated magnetic field causes magnetization within the central core 432 of the rotor 430, and magnetic effects are conveyed by the rotor out to the outer body 434 and outer fins 438. As the magnetically affected outer fins 438 turn within the first output winding 420 by rotation of the shaft 304, an oscillating voltage is induced in the output winding. Such an oscillating voltage is known in the electrical arts as an alternating-current (AC) voltage. Thus, an electrical AC voltage in the output winding is induced and controlled by the first current passed through the first field winding 410 and by rotation of the rotor 430 without any electrically conducting brush contact abutting the rotor, the shaft, or any other rotating component. Therefore these descriptions refer to the winding assembly 400 as a brushless winding assembly.

The second brushless winding assembly 500 includes a second field winding 510, a second output winding 520, and a second rotor 530. From a broad perspective, the second brushless winding assembly 500 and its components are functionally equivalent to the first brushless winding assembly 400 and its corresponding components and so a further detailed description need not be duplicated here.

A first rectifier 50 and a second rectifier 52 are within the housing 302 of FIG. 8 and are schematically represented in FIG. 2 as well. The first and second rectifiers 50 and 52 are electrically connected to the first and second output windings 420 and 520, respectively. The first rectifier 50 receives the first AC voltage from the first output winding 420 and produces a first direct-current (DC) voltage. The second rectifier 52 receives the second AC voltage from the second output winding 520 and produces a second direct-current (DC) voltage. Like the first and second AC voltages, the first and second DC voltages may be the same or different in any given operational situation of the double alternator 300.

The first and second DC voltages produced by the first and second rectifiers 50 and 52 are conveyed through the housing to first and second electrical output contacts 450 and 550 by respective conducting wires, strips, or connectors. The first and second electrical contacts are electrically connected to the first and second rectifiers 50 and 52, respectively, to receive the first and second DC voltages and to make those voltages available to loads and devices electrically downstream of the double alternator 300. The first and second electrical output contacts 450 and 550 are electrically isolated from the housing to prevent unwanted grounding and to minimize the likelihood of electrical shocks. Two first electrical output contacts 450 are shown in FIG. 8 to represent that two output contacts are provided for the first brushless winding assembly 400 in order to convey the first DC voltage through the housing as an electrical potential difference between the two contacts. The second DC voltage is similarly expressed as an electrical potential difference between the two second electrical output contacts 550. In another embodiment of a double alternator according to at least one embodiment of the invention, internal grounding is utilized and a single first electrical output contact 450 and a single second electrical output contact 550 are electrically isolated from the housing to convey the first DC voltage and the second DC voltage through the housing respectively. In that embodiment, the first and second DC voltages are each expressed as an electrical potential difference between its single electrical output contact 450 and the housing 302.

First and second electrical input contacts 452 and 552 are also shown in FIG. 8. These contacts carry the first and second electrical currents that are passed through the first and second field windings 410 and 510, respectively, to generate magnetic fields to cause magnetization of the rotors 430 and 530 and the induction of the first and second AC voltages in the first and second output windings upon rotation of the shaft 304. Two first electrical input contacts 452 are shown to represent that current passed through the first field winding enters the double alternator 300 by one of the two contacts and exits by the other. Two second electrical input contacts 552 are similarly shown. The first and second electrical input contacts 452 and 552 are electrically isolated from the housing to prevent unwanted grounding and to minimize the likelihood of electrical shocks.

Although the second brushless winding assembly 500 and its components are functionally equivalent to the first brushless winding assembly 400 and its components from a broad perspective, it should be noted that, from a more specific perspective, various dimensions and other construction parameters may differ between the first and second brushless winding assemblies. For example, the number of turns in the first and second field windings 410 and 510 may be the same or may differ. Thus, within the scope of these descriptions, the first and second brushless winding assemblies may be identically constructed as depicted in FIG. 8 or they may be of different sizes and configurations.

As the electrical response characteristics of the first and second brushless winding assemblies 400 and 500 are governed by their constructions, the first AC voltage induced in the first output winding 420 and the second AC voltage induced in the second output winding 520 may be the same or may be different at any given rotation rate of the shaft 304. Likewise, the first and second DC voltages provided at the first and second electrical output contacts 450 and 550, respectively, may be the same or may differ at any given rotation rate of the shaft 304 according to the design preferences prevailing in any particular double alternator constructed according to these descriptions. The electrical currents that result when such a double alternator 300 is placed into service will likely vary according to the devices placed downstream of the alternator. Thus, the electrical currents in terms of amperage flowing through the first electrical output contacts 450 may be the same or may differ from the electrical currents flowing through the second electrical output contacts 550.

The first and second brushless winding assemblies 400 and 500 rely upon the same shaft 304 and their rotors 430 and 530 therefore rotate together with the shaft at the same rate. Nonetheless, their output voltages and currents can be varied independently according to the first and second currents provided to the first and second field windings 410 and 510 through the first and second electrical input contacts 452 and 552. Such currents are provided and regulated by an external current source. For example, as represented in FIG. 2, the first and second voltage regulators 124 and 125 are electrically connected to the first and second halves 11 and 13 of a double alternator. This represents that the first and second voltage regulators 124 and 125 are electrically connected the first and second field windings 410 and 510 to provide the first and second currents which ultimately induce and control the electrical AC voltages in the output windings 420 and 520 when the first and second brushless winding assemblies 400 and 500 serve in lieu of the first and second halves 11 and 13 in the electrical system of FIG. 2.

FIG. 7 also shows voltage regulators 202 and 204 electrically connected to the first and second halves 11 and 13 of a double alternator similarly representing that the first and second voltage regulators 202 and 204 are electrically connected the first and second field windings 410 and 510 to provide the first and second currents when the first and second brushless winding assemblies 400 and 500 serve in lieu of the first and second halves 11 and 13 in the electrical system of FIG. 2. Indeed, in each of FIGS. 2-7, the first and second halves 11 and 13 of the double alternator 10 of FIG. 1 may be replaced by the first and second brushless winding assemblies 400 and 500 of the double alternator 300 of FIG. 8. Thus, according to various electrical system embodiments described herein and illustrated in the drawings, certain embodiments of a double alternator according to these descriptions include first and second voltage regulators configured to maintain the first and second DC voltages produced by the first and second rectifiers 50 and 52 at first and second predetermined values, respectively. In one such embodiment, the first and second predetermined values are different, and in another embodiment, the first and second predetermined values are substantially the same.

The double alternator 10 illustrated in FIG. 1 includes brushes for carrying electrical current to rotating components, while the double alternator 300 has brushless winding assemblies. In yet another embodiment of the invention, a double alternator includes one brushed winding assembly and one brushless winding assembly. FIGS. 1 and 9 relate to this other embodiment in that the output winding 420, the field winding 410 and the rotor 430 of FIG. 9 together replace the stator 40 and the rotor 30 of FIG. 1 in constructing this other embodiment. Thus, by such construction, the output winding 420 serves in a role similar to that of the stator 40, while the field winding 410 and rotor 430 together supplant the rotor 30. According to this other embodiment then, the stator 42 and the rotor 32 together serve as a brushed winding assembly while the output winding 420, the field winding 410 and the rotor 430 together serve as a brushless winding assembly, and both the brushed winding assembly and brushless winding assembly rely upon the rotation of the shaft 24 for electrical power production.

A double alternator according to these descriptions can provide two alternator portions having the same or different phase outputs. For example, in one embodiment according to these descriptions, both alternator portions provide a three phase output. In another embodiment, one alternator portion provides a three phase output, and another alternator portion provides a four phase output. In yet another embodiment, at least one alternator portion provides a phase output of greater than four. A double alternator according to these descriptions can provide electrical outputs from the output windings in order to provide AC outputs. For example, in at least one embodiment, one alternator portion provides an AC output, and another alternator portion provides a DC output. The shaft 24 can be driven by a belt, a coupling, a gear, or by other means. According to these descriptions, the voltages input to and output from a double alternator are variable and may be the same or different for two alternator portions. For example, in at least one embodiment, a first alternator portion serves as a 6 volt alternator, and a second alternator portion serves as a 12 volt alternator. In another embodiment, at least one alternator portion serves as a 24 volt alternator. Similarly, the two alternator portions may provide the same or different amperages. For example, in at least one embodiment, a first alternator portion provides 30 amps and a second alternator portion provides 70 amps.

Embodiments of a double alternator and electrical systems having double alternators are described above. Various details of the invention may be changed without departing from its scope. Furthermore, the foregoing description of the preferred embodiments of the invention and best mode for practicing the invention are provided for the purpose of illustration only and not for the purpose of limitation.

What is claimed is:

1. A double alternator comprising:
a housing;
a shaft rotatably mounted in the housing;
a first brushless winding assembly including a first field winding fixed in the housing, a first output winding fixed in the housing, and a first rotor fixed to the shaft to rotate relative to the first field winding and first output winding to induce a first AC voltage in the first output winding upon an introduction of a first current in the first field winding and rotation of the shaft;
a first rectifier within the housing and electrically connected to the first output winding to produce a first DC voltage upon induction of the first AC voltage;
a first electrical output contact electrically isolated from the housing and electrically connected to the first rectifier to convey the first DC voltage through the housing;
a second winding assembly disposed within the housing and about the shaft to induce a second AC voltage upon rotation of the shaft;
a second rectifier within the housing and electrically connected to the second winding assembly to produce a second DC voltage upon induction of the second AC voltage; and
a second electrical output contact electrically isolated from the housing and electrically connected to the second rectifier to convey the second DC voltage through the housing.

2. A double alternator according to claim 1, wherein the second winding assembly defines a second brushless assembly and comprises a second field winding fixed in the housing, a second output winding fixed in the housing, and a second rotor fixed to the shaft to rotate relative to the second field winding and second output winding to induce the second AC voltage in the second output winding upon an introduction of a second current in the second field winding and rotation of the shaft.

3. A double alternator according to claim 2, further comprising:
a first voltage regulator electrically connected to the first field winding to provide the first current; and
a second voltage regulator electrically connected to the second field winding to provide the second current.

4. A double alternator according to claim 3, wherein:
the first voltage regulator comprises a first shunt electrically connected to the first rectifier to measure the first DC voltage and is configured to regulate the first current according to the measured first DC voltage; and
the second voltage regulator comprises a second shunt electrically connected to the second rectifier to measure the second DC voltage and is configured to regulate the second current according to the measured second DC voltage.

5. A double alternator according to claim 4, wherein:
the first voltage regulator is configured to maintain the first DC voltage at a first predetermined value by regulating the first current; and
the second voltage regulator is configured to maintain the second DC voltage at a second predetermined value by regulating the second current.

6. A double alternator according to claim 5, wherein the first predetermined value is different from the second predetermined value.

7. A double alternator according to claim 5, wherein the first predetermined value is substantially the same as the second predetermined value.

8. A double alternator according to claim 1, wherein the first DC voltage is different from the second DC voltage.

9. A double alternator according to claim 1, wherein the first DC voltage is substantially the same as the second DC voltage.

10. A double alternator according to claim 1, wherein the second winding assembly defines a brushed winding assembly comprising a second output winding fixed to the housing, a rotor having a second field winding fixed to the shaft to rotate relative to the second output winding to induce the second AC voltage upon an introduction of a second current in the second field winding and rotation of the shaft, a slip ring fixed to the shaft and electrically connected to the second field winding, and a brush fixed relative to the housing and contacting the slip ring to provide the second current to the second field winding through the slip ring.

11. A double alternator comprising:
a housing;
a shaft rotatably mounted in the housing;
a first brushless winding assembly disposed within the housing and about the shaft to generate a first AC voltage upon rotation of the shaft;
a first rectifier electrically connected to the first brushless winding assembly to produce a first DC voltage upon generation of the first AC voltage;
a second winding assembly disposed within the housing and about the shaft to generate a second AC voltage upon rotation of the shaft;
a second rectifier electrically connected to the second winding assembly to produce a second DC voltage upon generation of the second AC voltage;
a first electrical output contact disposed outside the housing and electrically connected to the first rectifier to receive the first DC voltage; and
a second electrical output contact disposed outside the housing and electrically connected to the second rectifier to receive the second DC voltage.

12. A double alternator according to claim 11, further comprising a pulley fixed to the shaft to forcibly rotate the shaft to cause production of the first DC voltage and second DC voltage.

13. A double alternator according to claim 11, wherein the second winding assembly defines a brushless second winding assembly.

14. A double alternator according to claim 13, wherein the second winding assembly defines a brushed second winding assembly.

15. A double alternator comprising:
a first brushless winding assembly to generate a first electrical voltage;
a second winding assembly to generate a second electrical voltage;
a rotatable shaft common to the first brushless winding assembly and second winding assembly to cause generation of the first electrical voltage and second electrical voltage upon rotation of the shaft; and
a housing in which said winding assemblies are disposed and through which said first and second electrical voltages are carried to respective first and second electrical output contacts.

16. A double alternator according to claim 15, wherein:
the first brushless winding assembly includes a first field winding, a first output winding, and a first rotor fixed to the shaft to rotate with the shaft, the first rotor having at least a portion disposed between the first field winding and the first output winding; and
the second winding assembly defines a brushless second winding assembly that includes a second field winding, a second output winding, and a second rotor fixed to the shaft to rotate with the shaft, the second rotor having at least a portion disposed between the second field winding and the second output winding.

17. A double alternator according to claim 16, further comprising:
a first voltage regulator electrically connected to the first field winding to provide a first current to the first field winding; and
a second voltage regulator electrically connected to the second field winding to provide a second current to the second field winding.

18. A double alternator according to claim 17, wherein:
the first voltage regulator is configured to maintain the first electrical voltage at a first predetermined value by regulating the first current; and
the second voltage regulator is configured to maintain the second electrical voltage at a second predetermined value by regulating the second current.

19. A double alternator according to claim 18, wherein the first predetermined value is different from the second predetermined value.

20. A double alternator according to claim 18, wherein the first predetermined value is substantially the same as the second predetermined value.

21. A double alternator according to claim 15, wherein the second winding assembly defines a brushed second winding assembly.
